(19) United States
(12) Patent Application Publication
(10) Pub. No.: US 2013/0068753 A1
(43) Pub. Date: Mar. 21, 2013

(54) ELECTROTHERMAL ARTICLE WITH A FOLDABLE STRUCTURE

(71) Applicant: CHUNG-YENG LIN, Taichung City (TW)

(72) Inventor: CHUNG-YENG LIN, Taichung City (TW)

(21) Appl. No.: 13/237,981

(22) Filed: Sep. 21, 2011

(51) Int. Cl. H05B 3/34

(52) U.S. Cl. 219/529

(57) ABSTRACT

An electrothermal article with a foldable structure includes an upper sheet and a lower sheet both made from a hot-melt gum, a bundle of fibers made from a carbon fiber or a stainless steel. The fibers are received between the up and lower sheets and arranged as a sinusoid. After a thermal pressing step, the shape and the location of the fibers are fixed with the two sheets. In this arrangement, the heating wire is difficult to break when bent inappropriately or during a washing operation. In addition, the fibers are never exposed into the air along the seaming line for a long period using.

### BACKGROUND OF THE INVENTION

1. Field of the Invention

The present invention relates to an electrothermal article, more particularly to an electrothermal article with a foldable structure.

2. Description of Related Art

Electrothermal articles commonly used in our daily life include electric blankets and mattress pads. A conventional heating blanket includes an upper fabric sheet, a lower fabric sheet, an inner space defined between the upper and lower fabric sheet and a heating wire, which is generally made from a nickel-chromium material, and which is meanderingly disposed in the inner space. However, the user will feel uncomfortable when sitting on the heating blanket due to the thickness and hardness of the heating wire. In addition, the heating wire of the conventional heating blanket may break when bent inappropriately or during a washing operation.

In order to overcome the disadvantage mentioned above, a manufacturer invents a carbon fiber with well electrothermal conductivity and elasticity instead of the nickel-chromium material. However, the fiber is often coating a thin membrane, which is an electrical insulator, and then seaming into the fabric sheets. When the electrothermal article is used for a long time, the fibers are exposed into the air along the seaming line. Thus, how to design one suitable structure for receiving the fiber is necessary in this field.

The present invention has arisen to mitigate and/or obviate the disadvantages of the conventional.

### SUMMARY OF THE INVENTION

The main objective of the present invention is to provide an improved electrothermal article with a foldable structure.

To achieve the objective, an electrothermal article with a foldable structure comprises an upper sheet and a lower sheet both made from a hot-melt gum, a bundle of fibers made from a carbon fiber or any material with well electrothermal conductivity and elasticity, two terminals formed at two ends of the bundle of fibers respectively; wherein the bundle of fibers is placed on the lower sheet flatly and is arranged as a sinusoid, thereafter the lower sheet with fibers is placed into a thermal pressing module and the upper sheet covers the lower sheet and fibers completely; after a thermal pressing step, the upper sheet glues to the lower sheet and the location of the fibers are fixed within the upper and lower sheets; two terminals are exposed out of the upper and lower sheet for conducting electricity and the electrothermal article is heated up by the current passing through the fibers.

A thermal-isolated layer is attached on the upper sheet.

A diameter of each fiber is between 0.007˜0.01 mm.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of an electrothermal article with a foldable structure in accordance with the present invention;

FIG. 2 is an assembled view of the electrothermal article with a foldable structure in accordance with the present invention; and

FIG. 3 is a cross-sectional view for showing the electrothermal article with a foldable structure along line 33 in FIG. 2.

### DETAILED DESCRIPTION OF THE INVENTION

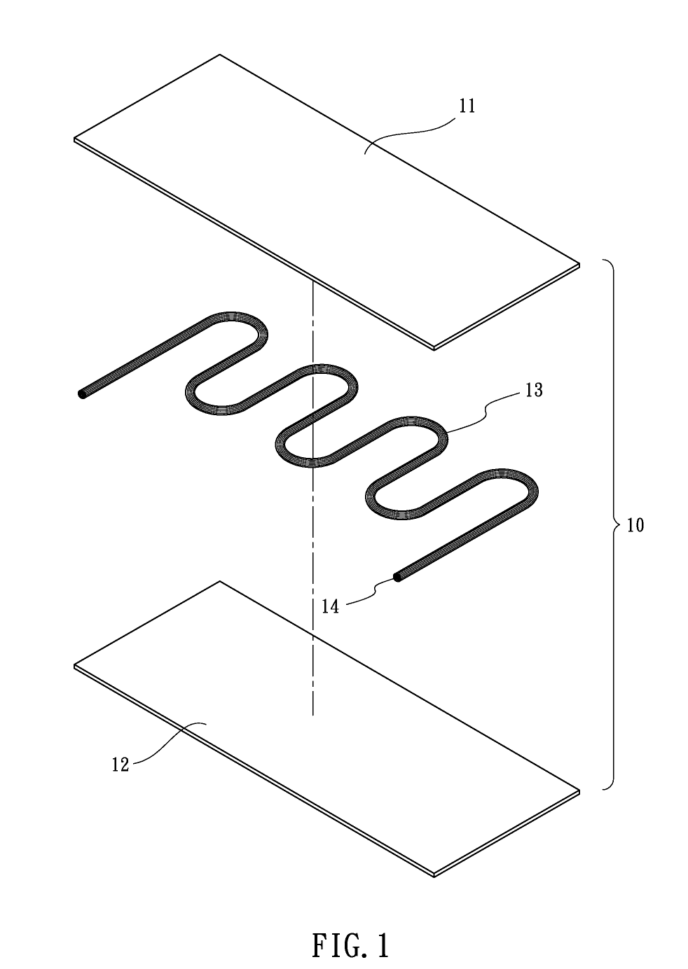

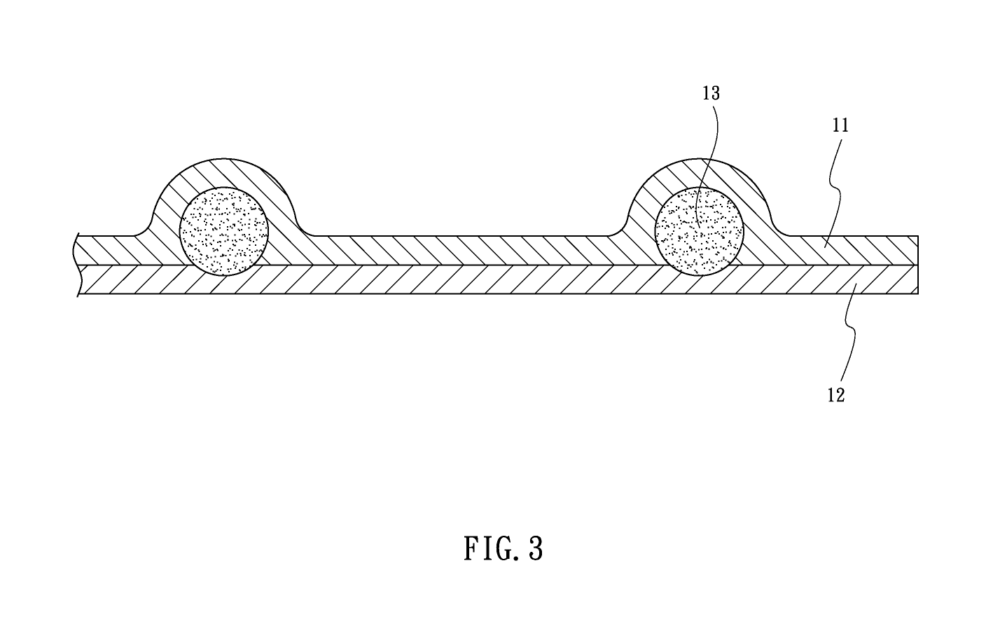

Referring to FIGS. 1-3, an electrothermal article 10 with a foldable structure in accordance with the present invention comprises an upper sheet 11 and a lower sheet 12 which are made from a hot-melt gum. A bundle of fibers 13 is made from a carbon fiber, a stainless steel, or other materials with well electrothermal conductivity and elasticity.

The fibers 13 are received between the up and lower sheets 11, 12. A diameter of each fiber is between 0.007˜0.01 mm. Two terminals 14 are formed at two ends of the bundle of fibers 13 respectively for conducting to the electricity. The electrothermal article 10 is heated up by the current passing through the fibers 13.

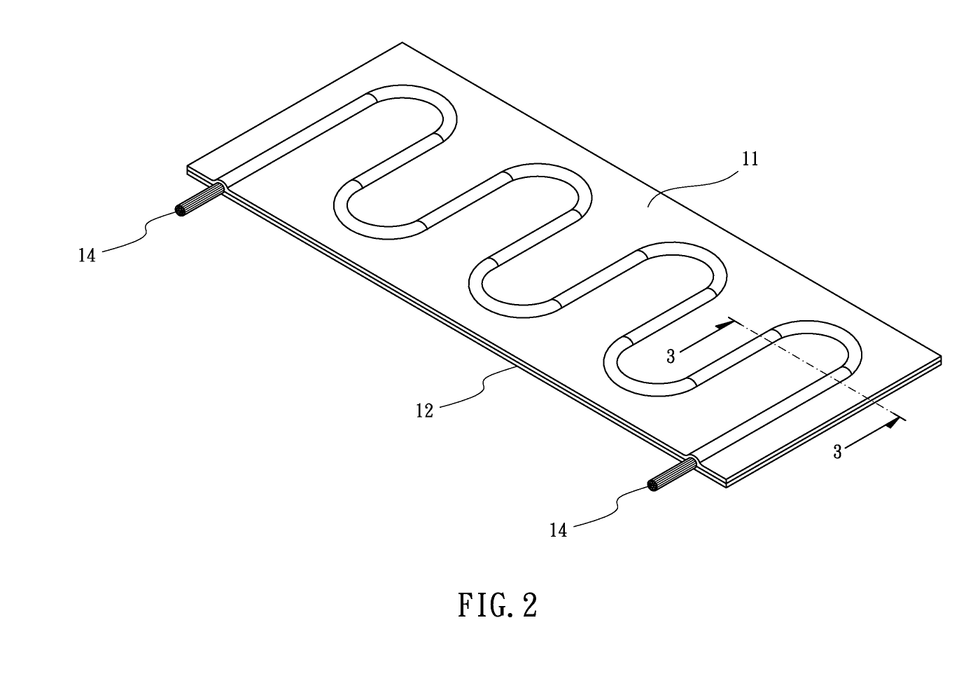

When a manufacturer assembles the up sheet 11, lower sheet 12, and the fibers 13 to produce one electrothermal article 10, the bundle of fibers 13 is placed on the lower sheet flatly and is arranged as a sinusoid as shown in FIGS. 1-2. An interval between each sinusoid of the bundle of fibers 13 is depended on a size of the electrothermal article 10, the highest temperature condition by electrically heating, and a thermal gradient on the electrothermal article 10. Thereafter, the lower sheet 12 with fibers 13 is placed into a thermal pressing module and the upper sheet 11 covers the lower sheet 12 and fibers 13 completely. After a thermal pressing step, the upper sheet 11 glues to the lower sheet 12 and the location of the fibers 13 are fixed within the upper and lower sheets 11, 12. Two terminals 14 are exposed out of the upper and lower sheet 11, 12 for conducting to the electricity.

Furthermore, a thermal-isolated layer is attached on the upper sheet 11 for limiting the heat to flow into the air and limiting the highest temperature on the surface of the electrothermal article 10.

Some advantage of the present invention is disclosed as following:

First, there is no seaming structure so that the fibers 13 never expose into the air along the seaming structures;

Second, after the thermal pressing step, the hot-melt gum becomes flexible and hard so that the electrothermal article 10 cannot break and the surface of the electrothermal article 10 is too hard to scrape;

Third, there are some tiny spaces between each sinusoid of fibers 13 and two sheets 11, 12, and these spaces are filled of the air to form a natural electrical insulator.

Although the invention has been explained in relation to its preferred embodiment, it is to be understood that many other possible modifications and variations can be made without departing from the spirit and scope of the invention as hereinafter claimed.

What is claimed is:

1. An electrothermal article with a foldable structure comprising:
an upper sheet and a lower sheet both made from a hot-melt gum;
a bundle of fibers made from a carbon fiber or any material with well electrothermal conductivity and elasticity; and
two terminals formed at two ends of the bundle of fibers respectively;
wherein the bundle of fibers is placed on the lower sheet flatly and is arranged as a sinusoid, thereafter the lower sheet with fibers is placed into a thermal pressing module and the upper sheet covers the lower sheet and fibers completely; after a thermal pressing step, the upper sheet glues to the lower sheet and the location of the fibers are fixed within the upper and lower sheets; two terminals are exposed out of the upper and lower sheet for conducting to the electricity and the electrothermal article is heated up by the current passing through the fibers.

2. The electrothermal article with a foldable structure as claimed in claim 1, wherein a thermal-isolated layer is attached on the upper sheet.

3. The electrothermal article with a foldable structure as claimed in claim 1, wherein a diameter of each fiber is between 0.007˜0.01 mm.
